(19) United States
(12) Patent Application Publication
(10) Pub. No.: US 2017/0352951 A1
(43) Pub. Date: Dec. 7, 2017

(54) COIL-TYPE LOOP ANTENNA FOR MOBILE DEVICE

(71) Applicant: HCTM CO., LTD., lcheon-si, Gyeonggi-do (KR)

(72) Inventor: Seungjae Lee, Suwon-si (KR)

(73) Assignee: HCTM CO., LTD., lcheon-si, Gyeonggi-do (KR)

(21) Appl. No.: 15/526,350

(22) PCT Filed: Jun. 8, 2015
(86) PCT No.: PCT/KR2015/005730

§ 371 Date: May 12, 2017

(30) Foreign Application Priority Data
Nov. 13, 2014 (KR) 10-2014-0158206
Mar. 19, 2015 (KR) 10-2015-038435

(51) Int. Cl. H01Q 1/52; H01Q 7/06; H01Q 1/22; H04R 9/02; G06K 19/077

(52) U.S. Cl. CPC H01Q 1/528; H04R 9/02; G06K 19/07773; H01Q 1/22; H01Q 7/06

(57) ABSTRACT

A coil-type loop antenna for a mobile device is installed in a mobile device, and includes an antenna coil which is arranged in the form of a coil wound around the outside surface of a housing of a permanent magnet structure having a permanent magnet on the inside thereof.

### TECHNICAL FIELD

The present disclosure relates to a mobile device with a coil-type loop antenna installed in it, and more particularly, to a coil-type loop antenna for a mobile device, which is provided around a receiver or speaker with a permanent magnet of the mobile device installed therein, so that propagation interference caused by characteristics of the material of a case may be minimized, antenna transmission and reception efficiency may be increased by use of a magnetic field of the permanent magnet, and a product may be miniaturized due to a decrease in the volume required for antenna installation.

### BACKGROUND ART

In general, a mobile device is a kind of terminal that a user uses for mobile communication, which is capable of exchanging signals such as voice, images, and data with the other party during roaming.

In addition to actual communication, the mobile device is equipped with additional functions such as e-book, MP3, camera, recorder, scanner, multimedia play, and gaming. With a tablet computer function added, an advanced device serving as a smartphone has recently been commercialized.

Further, as the mobile device is equipped with a Near Field Communication (NFC) function, the mobile device finds its applications for a contact-free credit card, electronic payment, identification, and so on. Since NFC uses a radio signal in a frequency band as defined by a specific standard, NFC requires an antenna which is typically a loop antenna pattern.

NFC is a short-range wireless communication technology for data communication in a predetermined frequency band at a short distance. NFC is characterized by less power consumption and compatibility with contact-free Radio Frequency IDentification (RFID). NFC schemes are classified into active communication schemes and passive communication schemes.

In NFC, a history or information about each product or item is acquired by reading information written in the memory of a tag attached to the product or item in a read mode, or bi-directional communication is conducted in a Peer-to-Peer (P2P) mode, for electronic payment or one-to-one communication. For NFC, therefore, electronic circuits and antennas of a transmitter and a receiver need to be configured to recognize each other and operate by exchanging signals in a radio frequency of a specific frequency band.

To transmit and receive NFC signals, a built-in antenna connected to the main board of the mobile device is installed inside the mobile device. To minimize signal interference with internal electronic parts of the mobile device, the antenna is disposed in a rear case, apart from the internal electronic parts.

In regards to a conventional loop antenna installed in a rear case, since an antenna installation space needs to be secured in the rear case, the space is spared in consideration of a required volume for the antenna during manufacture of the case, which makes product miniaturization difficult.

Moreover, as the case of a mobile device has recently been fabricated of a metal, signal interference occurs to a built-in loop antenna installed in a rear cover of the mobile device, resulting in a decrease in the transmission and reception efficiency of signals. That is, when the magnetic field of the loop antenna is formed, the metal interferes with the magnetic field formation, thereby decreasing the accurate radiation efficiency of NFC signals.

In addition, since the conventional loop antenna has a structure in which an antenna is disposed inside the case, and requires installation of various parts for the antenna, it suffers from the increase of production cost.

### DISCLOSURE

### Technical Problem

An aspect of the present disclosure devised to solve the conventional problem is to provide a coil-type loop antenna for a mobile device, which is installed by winding a coil around a speaker of the mobile device, so that transmission and reception efficiency may be increased by means of a permanent magnet of the speaker, and a volume required for antenna installation may be reduced, thereby making product miniaturization possible.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In an aspect of the present disclosure, a coil-type loop antenna for a mobile device is installed in the mobile device, and includes an antenna coil wound around an outer surface of a housing of a permanent magnet structure having a permanent magnet installed therein.

The permanent magnet structure may be a speaker.

The permanent magnet structure may be a receiver.

The outer surface of the housing may be an outer circumferential surface of the housing, and the antenna coil may be wound around the permanent magnet structure.

The outer surface of the housing may be a top surface of the housing, and the antenna coil may be wound on a top surface of the permanent magnet structure.

The outer surface of the housing may be a bottom surface of the housing, and the antenna coil may be wound on a bottom surface of the permanent magnet structure.

The outer surface of the housing may be an outer circumferential surface of the housing, the antenna coil may be wound a plurality of times around a part of the outer circumferential surface of the housing, and a magnetic field inductor may be provided around the remaining part of the outer circumferential surface of the housing.

The outer surface of the housing may be an outer circumferential surface of the housing, the antenna coil may be wound around the permanent magnet structure, and a magnetic field inductor may be disposed between the outer circumferential surface of the housing and the antenna coil, surrounding a part of the outer circumferential surface of the housing.

The magnetic field inductor may be formed of a metal.

The magnetic field inductor may be formed of ferrite.

The magnetic field inductor may be formed of a magnetic rubber.

Details of other embodiments lie within the detailed description of the present disclosure and the drawings.

### Advantageous Effects

According to a coil-type loop antenna for a mobile device according to an embodiment of the present disclosure, the antenna is installed outside a speaker of the mobile device. As the antenna is configured using a magnetic field of a permanent magnet of the speaker, a required volume for the antenna is reduced, thereby enabling product miniaturization.

As the coil-type loop antenna for a mobile device according to the present disclosure is configured to transmit and receive Near Field Communication (NFC) signals by use of the magnetic field of the permanent magnet installed in the speaker, propagation interference of a metal case may be minimized. The resulting increase of antenna reception efficiency may lead to performance improvement.

Particularly, even though the case is formed of a metal causing interference to transmission and reception of the loop antenna, the effect of the interference may be minimized by the magnetic field of the permanent magnet of the speaker. Accordingly, transmission and reception performance of NFC signals may be maintained.

Further, in a coil-type loop antenna for a mobile device according to an embodiment of the present disclosure, since a magnetic field generated from an antenna coil wound around a speaker serves as an antenna, the installation space of the speaker may be utilized. The decrease of a volume required for the antenna may lead to saving the space of the mobile device, thereby enabling product miniaturization.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

FIG. 1 is a use state diagram illustrating an installation state of a coil-type loop antenna for a mobile device according to an embodiment of the present disclosure.

FIG. 2 is a perspective view illustrating a main part in which the coil-type loop antenna for a mobile device illustrated in FIG. 1 is installed.

FIG. 3 is a front view illustrating an operation state of the coil-type loop antenna for a mobile device, illustrated in FIG. 1.

FIG. 4 is a perspective view illustrating the operation state of the coil-type loop antenna for a mobile device, illustrated in FIG. 1.

FIG. 5 is a sectional view illustrating the operation state of the coil-type loop antenna for a mobile device, illustrated in FIG. 1.

FIG. 6 is a sectional view illustrating an installation state of a coil-type loop antenna for a mobile device according to another embodiment of the present disclosure.

FIG. 7 is a sectional view illustrating an installation state of a coil-type loop antenna for a mobile device according to a third embodiment of the present disclosure.

FIG. 8 is a sectional view illustrating an installation state of a coil-type loop antenna for a mobile device according to a fourth embodiment of the present disclosure.

FIG. 9 is a sectional view illustrating an installation state of a coil-type loop antenna for a mobile device according to a fifth embodiment of the present disclosure.

<Description of Reference Numerals for Main Components in
the Drawings>

| | |
|---|---|
| 1: mobile device | 10: case |
| 20: speaker | 21: housing |
| 22: permanent magnet | 23: speaker coil |
| 24: diaphragm | 25: gasket |
| 100: loop antenna | 110: antenna coil |
| 111: coil connector | 120: magnetic field inductor |

### MODE FOR CARRYING OUT THE INVENTION

The objects and effects of the present disclosure, and technical configurations to achieve them will become apparent upon examination of the following embodiments of the present disclosure described with reference to the attached drawings. A detailed description of a generally known function or structure of the present disclosure will be avoided lest it should obscure the subject matter of the present disclosure. In addition, although the terms used in the present disclosure are defined in consideration of their structures, roles, and functions in the present disclosure, the terms may be changed according to the intention of a user or an operator, or customs.

However, the present disclosure may be implemented in various ways, not limited to the following embodiments. The embodiments of the present disclosure are provided to assist in a comprehensive understanding of the scope and spirit of the present disclosure, and the present disclosure is defined only by the appended claims and their equivalents. Therefore, the definition should be made based on the whole contents of the specification.

Now, a detailed description will be given of a coil-type loop antenna for a mobile device according to an embodiment of the present disclosure.

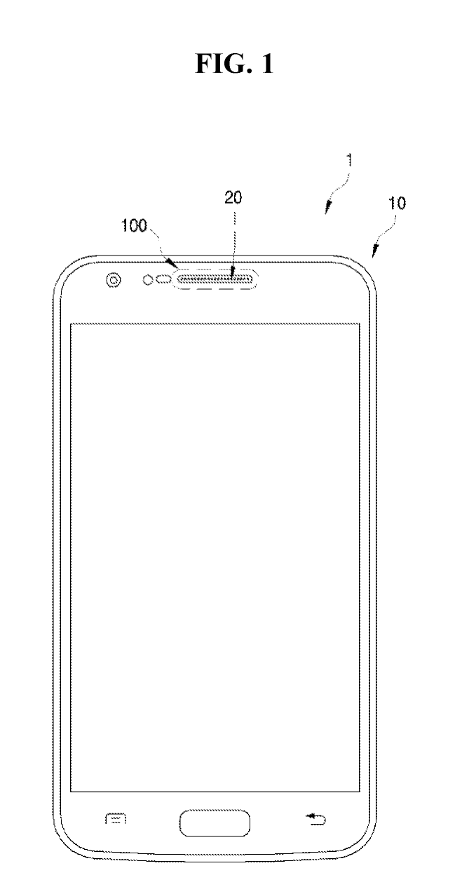

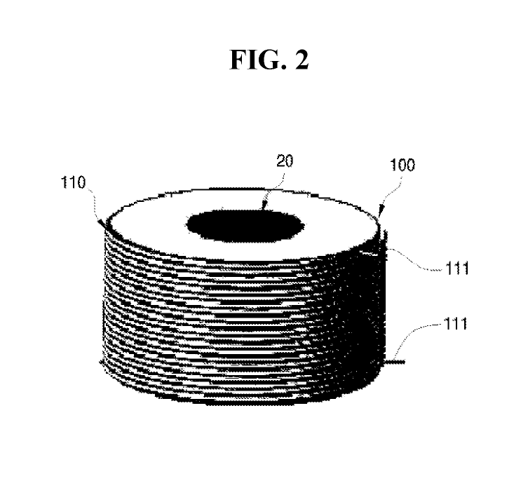

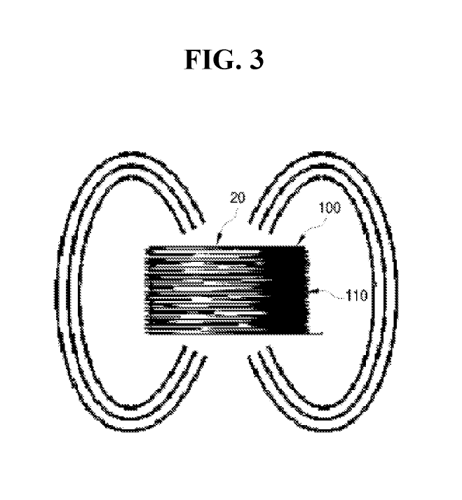

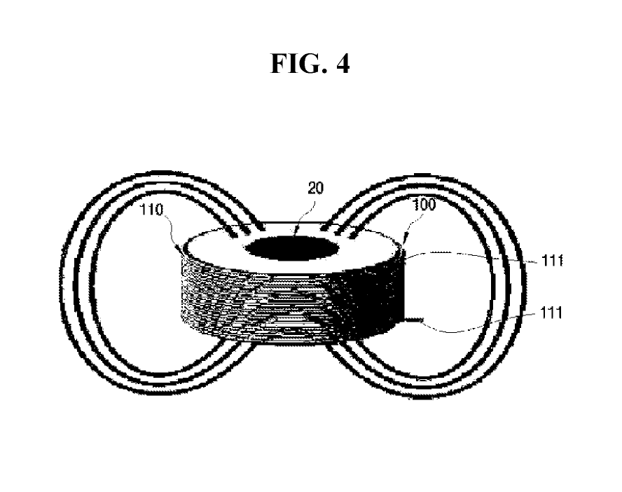

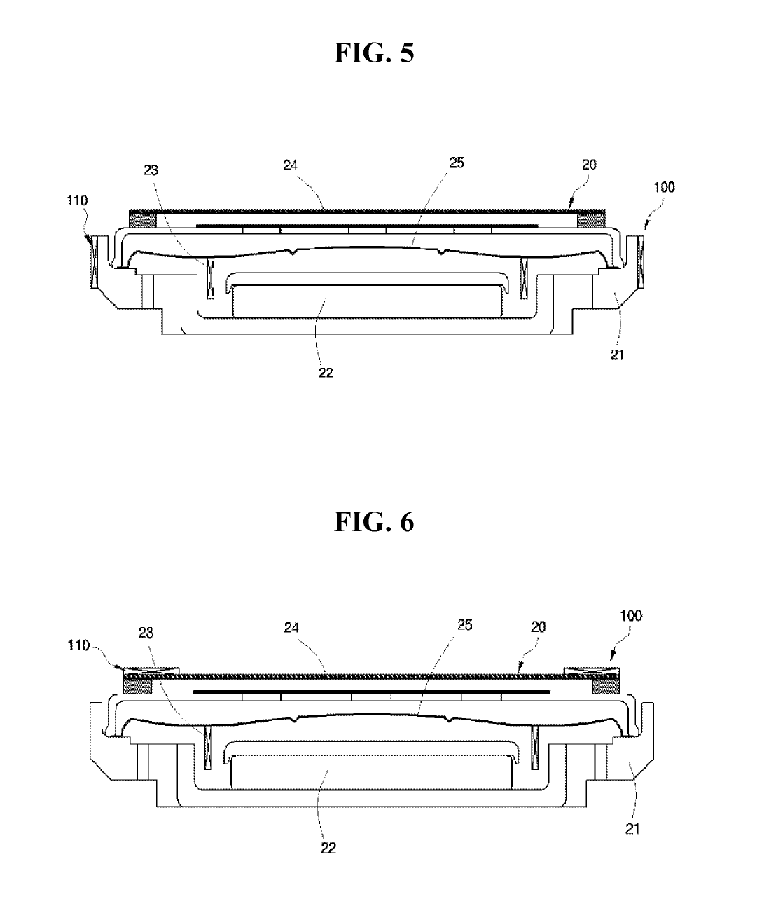

FIG. 1 is a use state diagram illustrating an installation state of a coil-type loop antenna for a mobile device according to an embodiment of the present disclosure, FIG. 2 is a perspective view illustrating a main part in which the coil-type loop antenna for a mobile device illustrated in FIG. 1 is installed, FIG. 3 is a front view illustrating an operation state of the coil-type loop antenna for a mobile device illustrated in FIG. 1, FIG. 4 is a perspective view illustrating the operation state of the coil-type loop antenna for a mobile device illustrated in FIG. 1, and FIG. 5 is a sectional view illustrating the operation state of the coil-type loop antenna for a mobile device illustrated in FIG. 1.

Referring to FIGS. 1 and 5, a coil-type loop antenna 100 for a mobile device according to an embodiment of the present disclosure is installed around a speaker 20 having a permanent magnet 22, among parts mounted in a mobile device 1, so as to transmit and receive signals through mutual resonation with Near Field Communication (NFC) signals.

The speaker 20 is given as an exemplary permanent magnet structure with the permanent magnet 22 installed therein, for the convenience of description. The coil-type loop antenna 100 for a mobile device is applicable to any part having the permanent magnet 22 installed therein in the mobile device 1. Particularly, it is apparent to those skilled in the art that a configuration in which the coil-type loop antenna 100 for a mobile device is installed in a receiver with the permanent magnet 22 installed therein may also fall within the scope of the present disclosure.

In other words, the coil-type loop antenna 100 for a mobile device may be installed in the receiver.

In the speaker 20 installed in the mobile device 1, a housing 21 is installed in a voice output part in a portion of a case 10. The permanent magnet 22 around which a speaker coil 23 is wound to resonate a diaphragm during voice output is mounted inside the housing 21. A gasket 25 is installed in the other portion of the housing 21, so that voice generated by resonation of the diaphragm 24 may pass through the gasket 25 to be output to the outside and the interior may be protected.

In this speaker 20, when a signal corresponding to voice is applied to the speaker coil 23 in the area of a magnetic field generated from the permanent magnet 22, the diaphragm 24 may be vibrated, and the resulting output voice may be output to the outside through the gasket 25. Thus, a user may recognize the voice.

As described above, the permanent magnet 22 mounted in the speaker 20 forms a magnetic field, for mutual resonation between the speaker coil 23 and a signal to vibrate the diaphragm 24. Therefore, in the case where the coil-type loop antenna 100 is installed around the housing 21, if a magnetic field of the coil-type loop antenna 200 is generated within the magnetic field formed by the permanent magnet 22, the magnetic fields are added up, thereby increasing transmission and reception efficiency.

That is, as the coil-type loop antenna 100 is located within the magnetic field of the permanent magnet 22, the strength of a magnetic field generated during generation of a signal in a specific frequency band mutually resonating with an NFC signal is increased. Therefore, the transmission and reception efficiency of the coil-type loop antenna 100 may be increased.

Particularly, if the case 10 of the mobile device 1 is fabricated of a metal, installation of the loop antenna inside the case 10 causes signal interference to the case 10 during transmission and reception of NFC signals in a specific frequency band, thereby decreasing transmission and reception efficiency. Accordingly, as the coil-type loop antenna 100 is wound in the form of a coil around the outer surface of the speaker 20 with the permanent magnet 22 installed therein, a magnetic field is generated from an antenna coil 110 within a magnetic field generated from the permanent magnet 22. The resulting maximization of the transmission and reception efficiency of NFC signals may lead to minimal signal interference with the metal case 10.

The coil-type loop antenna 100 for a mobile device according to the embodiment of the present disclosure includes the antenna coil 110 wound a plurality of times around the housing 21.

As the antenna coil 110 is wound around the housing 21 with the permanent magnet 22 installed therein, when power is supplied to the antenna coil 110, the antenna coil 110 generates a magnetic field for NFC transmission and reception within the magnetic field of the permanent magnet 22, and thus the strength of the magnetic field is increased, thereby minimizing the effect of external interference and increasing the transmission and reception efficiency of NFC signals.

A frequency may be controlled according to the number of windings of the antenna coil 110 around the housing 21 of the speaker 20. Therefore, once a user-desired specific frequency band is determined, the number of windings of the antenna coil 110 may be determined in consideration of the size of a magnetic field depending on the diameter of the housing 21 and the strength of a magnetic field generated from the permanent magnet 22.

Particularly, the magnetic field generated from the antenna coil 110 serves as a loop antenna for transmitting and receiving NFC signals. Therefore, the number of windings is preferably controlled according to a specific frequency band that may mutually resonate with NFC signals.

Since the coil-type loop antenna 100 is configured by winding the antenna coil 110 around the housing 21 having the permanent magnet 22 installed therein, the coil-type loop antenna 100 is easily installed and has a simple structure. In addition, since a mutually resonating frequency band may be controlled according to the number of windings of the antenna coil 110, the application range of the coil-type loop antenna 100 may be extended.

Further, coil connectors 111 may be provided at both ends of the antenna coil 110, for connection to a control circuit (not shown) installed in the case 10 of the mobile device 1. The coil connectors 111 may be installed to electrically connect the antenna coil 110 to the control circuit, for power supply during transmission and reception of NFC signals and transfer of signals transmitted and received by mutual resonation.

FIG. 6 is a sectional view illustrating an installation state of a coil-type loop antenna for a mobile device according to another embodiment of the present disclosure.

Referring to FIG. 6, the coil-type loop antenna 100 for a mobile device according to another embodiment of the present disclosure includes the antenna coil 110 wound a plurality of times on a top surface of the gasket 25, defined as a direction in which the gasket 25 of the housing 21 is installed.

The antenna coil 110 is wound on a top surface of the housing 21 having the permanent magnet 22 installed therein to a size predetermined according to the shape of a magnetic field of the permanent magnet 22 so as to amplify the magnetic field of the permanent magnet 22. As the antenna coil 110 is wound on the top surface of the housing 21, when power is supplied to the antenna coil 110, the antenna coil 110 generates an NFC transmission and reception magnetic field within the magnetic field of the permanent magnet 22. The resulting increased magnetic field strength leads to the increase of NFC transmission and reception efficiency, while minimizing the effect of external interference.

The coil connectors 111 may be provided at both ends of the antenna coil 110, for connection to the control circuit installed in the case 10 of the mobile device 1. The coil connectors 111 may be installed to electrically connect the antenna coil 110 to the control circuit, for power supply during transmission and reception of NFC signals and transfer of signals transmitted and received by mutual resonation.

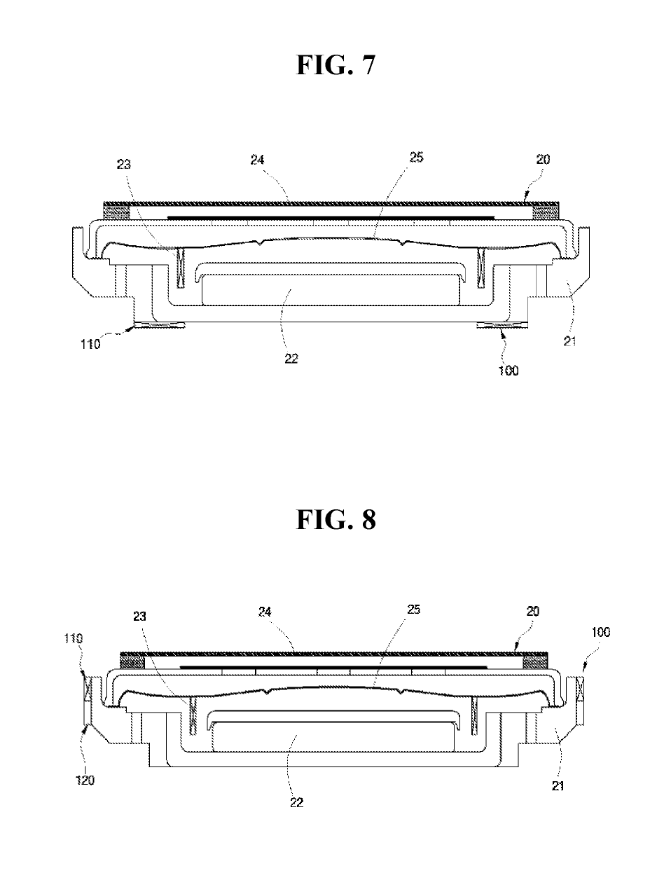

FIG. 7 is a sectional view illustrating an installation state of a coil-type loop antenna for a mobile device according to a third embodiment of the present disclosure.

Referring to FIG. 7, the coil-type loop antenna 100 for a mobile device according to the third embodiment of the present disclosure includes the antenna coil 110 wound a plurality of times on a bottom surface of the housing 21, defined as a direction opposite to the direction in which the gasket of the housing 21 is installed.

The antenna coil 110 is wound on the bottom surface of the housing 21 to a size predetermined according to the shape of a magnetic field of the permanent magnet 22 so as to amplify the magnetic field of the permanent magnet 22. As the antenna coil 110 is wound on the bottom surface of the housing 21, when power is supplied to the antenna coil 110, the antenna coil 110 generates an NFC transmission and reception magnetic field within the magnetic field of the permanent magnet 22. The resulting increased magnetic field strength leads to the increase of NFC transmission and reception efficiency, while minimizing the effect of external interference.

The coil connectors 111 may be provided at both ends of the antenna coil 110, for connection to the control circuit installed in the case 10 of the mobile device 1. The coil connectors 111 may be installed to electrically connect the antenna coil 110 to the control circuit, for power supply during transmission and reception of NFC signals and transfer of signals transmitted and received by mutual resonation.

FIG. 8 is a sectional view illustrating an installed state of a coil-type loop antenna for a mobile device according to a fourth embodiment of the present disclosure.

Referring to FIG. 8, the coil-type loop antenna 100 for a mobile device according to the fourth embodiment of the present disclosure includes the antenna coil 110 and a magnetic field inductor 120, each of which surrounds a part of the housing 21.

The antenna coil 110 is wound around a part of an outer surface of the housing 21, upward from the center. As power is supplied to the antenna coil 10 around the housing 21, induction of the magnetic field of the permanent magnet 22 installed inside the housing 21 through the magnetic field inductor 120 leads to generation of a magnetic field, thereby increasing NFC transmission and reception efficiency.

The coil connectors 111 may be provided at both ends of the antenna coil 110, for connection to the control circuit installed in the case 10 of the mobile device 1. The coil connectors 111 may be installed to electrically connect the antenna coil 110 to the control circuit, for power supply during transmission and reception of NFC signals and transfer of signals transmitted and received by mutual resonation.

The magnetic field inductor 120 surrounds the remaining part of the outer surface of the housing 21, downward from the center, apart from the antenna coil 110 in order to induce the magnetic field generated from the antenna coil 110. To avoid overlap with the antenna coil 110, for induction of the magnetic field generated from the antenna coil 110, the magnetic field inductor 120 is provided downward from the center on a partial outer surface of the housing except the surface surrounded by the antenna coil 110. Since the magnetic field inductor 120 is formed of a material that increases the generation efficiency of a magnetic field produced by current applied to the antenna coil 110, the magnetic field inductor 120 may increase the generation efficiency of the magnetic field.

The magnetic field inductor 120 is formed of a material that may induce a magnetic field when power is supplied to the antenna coil 110. Preferably, the magnetic field inductor 120 may be formed of one selected from a metal, ferrite being a magnetic material, and a magnetic rubber being an absorption material that has a magnetic force and absorbs an impact.

That is, the antenna coil 110 is provided upward from the center around the housing 21 and the magnetic field inductor 120 is provided downward from the center around the housing 21, so that the antenna coil 110 and the magnetic field inductor 120 may not overlap with each other. As the antenna coil 110 and the magnetic field inductor 120 are installed without overlap in predetermined areas of the outer surface of the housing 21, the magnetic field generated from the antenna coil 110 may be induced and a magnetic field induction direction may be set.

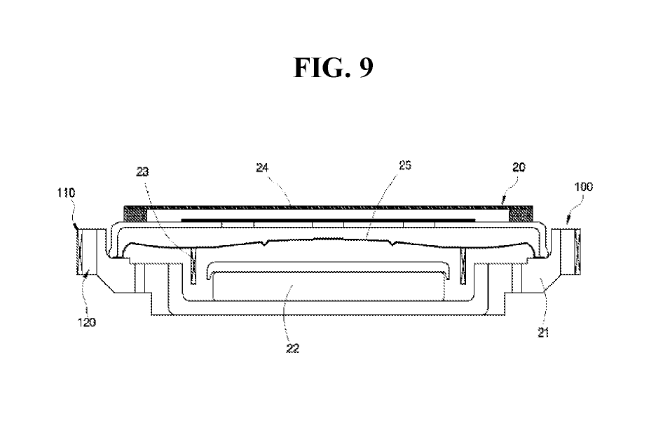

FIG. 9 is a sectional view illustrating an installed state of a coil-type loop antenna for a mobile device according to a fifth embodiment of the present disclosure.

Referring to FIG. 9, the coil-type loop antenna 100 for a mobile device according to the fifth embodiment of the present disclosure includes the magnetic field inductor 120 and the antenna coil 110 which ae wound around the housing 21.

The antenna coil 110 is wound a plurality of times around the housing 21. As power is supplied to the antenna coil 10 around the housing 21, induction of the magnetic field of the permanent magnet 22 installed inside the housing 21 through the magnetic field inductor 120 leads to generation of a magnetic field, thereby increasing NFC transmission and reception efficiency.

Further, the coil connectors 111 may be provided at both ends of the antenna coil 110, for connection to the control circuit installed in the case 10 of the mobile device 1. The coil connectors 111 may be installed to electrically connect the antenna coil 110 to the control circuit, for power supply during transmission and reception of NFC signals and transfer of signals transmitted and received by mutual resonation.

The magnetic field inductor 120 is disposed between the outer surface of the housing 21 and the antenna coil 110, surrounding a part of the outer surface of the housing 21. Since the magnetic field inductor 120 is formed of a material that increases the generation efficiency of a magnetic field generated by current applied to the antenna coil 110, the magnetic field inductor 120 may increases the generation efficiency of the magnetic field.

The magnetic field inductor 120 is formed of a material that may induce a magnetic field when power is supplied to the antenna coil 110. Preferably, the magnetic field inductor 120 may be formed of one selected from a metal, ferrite being a magnetic material, and magnetic rubber being an absorption material that has a magnetic force and absorbs an impact.

That is, the magnetic field inductor 120 surrounds the outer surface of the housing 21 and the antenna coil 110 is wound a plurality of times around the magnetic field inductor 120, so that the antenna coil 110 and the magnetic field inductor 120 may overlap with each other on the outer surface of the housing 21.

As the antenna coil 110 and the magnetic field inductor 120 are sequentially installed around the housing 21, overlapping with each other, the magnetic field generated from the antenna coil 110 may be induced and the generation efficiency of the magnetic field may be increased.

Preferred embodiments of the present disclosure have been disclosed in the specification and drawings. While specific terms are used, they are used in their general meaning to describe the present disclosure and assist understanding of the present disclosure, not limiting the scope of the present disclosure. It will be apparent to those skilled in the art that other modification examples than the disclosed embodiments can be implemented without departing from the scope and spirit of the present disclosure.

1. A coil-type loop antenna for a mobile device, the coil-type loop antenna being installed in the mobile device, and comprising an antenna coil wound around an outer surface of a housing of a permanent magnet structure having a permanent magnet installed therein.

2. The coil-type loop antenna according to claim 1, wherein the permanent magnet structure is a speaker.

3. The coil-type loop antenna according to claim 1, wherein the permanent magnet structure is a receiver.

4. The coil-type loop antenna according to claim 1, wherein the outer surface of the housing is an outer circumferential surface of the housing, and the antenna coil is wound around the permanent magnet structure.

5. The coil-type loop antenna according to claim 1, wherein the outer surface of the housing is a top surface of the housing, and the antenna coil is wound on a top surface of the permanent magnet structure.

6. The coil-type loop antenna according to claim 1, wherein the outer surface of the housing is a bottom surface of the housing, and the antenna coil is wound on a bottom surface of the permanent magnet structure.

7. The coil-type loop antenna according to claim 1, wherein the outer surface of the housing is an outer circumferential surface of the housing, the antenna coil is wound a plurality of times around a part of the outer circumferential surface of the housing, and a magnetic field inductor is provided around the remaining part of the outer circumferential surface of the housing.

8. The coil-type loop antenna according to claim 1, wherein the outer surface of the housing is an outer circumferential surface of the housing, the antenna coil is wound around the permanent magnet structure, and a magnetic field inductor is disposed between the outer circumferential surface of the housing and the antenna coil, surrounding a part of the outer circumferential surface of the housing.

9. The coil-type loop antenna according to claim 7, wherein the magnetic field inductor is formed of a metal.

10. The coil-type loop antenna according to claim 7, wherein the magnetic field inductor is formed of ferrite.

11. The coil-type loop antenna according to claim 7, wherein the magnetic field inductor is formed of a magnetic rubber.

12. The coil-type loop antenna according to claim 8, wherein the magnetic field inductor is formed of a metal.

13. The coil-type loop antenna according to claim 8, wherein the magnetic field inductor is formed of ferrite.

14. The coil-type loop antenna according to claim 8, wherein the magnetic field inductor is formed of a magnetic rubber.
